(19) United States
(12) Patent Application Publication
(10) Pub. No.: US 2025/0004762 A1
(43) Pub. Date: Jan. 2, 2025

(54) BINARY CONVOLUTION INSTRUCTIONS FOR BINARY NEURAL NETWORK COMPUTATIONS

(71) Applicant: TEXAS INSTRUMENTS INCORPORATED, Dallas, TX (US)

(72) Inventors: Mahesh Mehendale, Dallas, TX (US); Uri Weinrib, Mazkeret Batya (IL); Avi Berkovich, Herzeliya (IL)

(21) Appl. No.: 18/344,091

(22) Filed: Jun. 29, 2023

(51) Int. Cl. G06F 9/30

(52) U.S. Cl. CPC G06F 9/3001; G06F 9/30029; G06F 9/30036

(57) ABSTRACT

A system for accelerating binary convolution operations of a neural network includes a set of destination registers, binary convolution circuitry, a decoder coupled to the binary convolution circuitry, and instruction fetch circuitry coupled to the decoder and configured to fetch a binary convolution instruction from an associated memory. The binary convolution instruction specifies input data, weight data, and the set of destination registers for performing a binary convolution operation. The decoder receives the binary convolution instruction from the instruction fetch circuitry and causes the input data and the weight data to be provided to the binary convolution circuitry. In response, the binary convolution circuitry performs the binary convolution operation on the input data and the weight data to produce output data and stores the output data in the set of destination registers.

### TECHNICAL FIELD

Aspects of the disclosure are related to the field of computer hardware and software, and to new hardware instructions for binary neural network computations.

### BACKGROUND

Specially designed hardware-referred to as a hardware accelerator (HWA)—may be used to perform certain operations more efficiently when compared to software running on a general-purpose CPU. Indeed, hardware accelerators are frequently employed to improve performance and lower the cost of deploying machine learning applications, including at both the training and inference stages, including those of binary neural networks (BNNs).

A binary neural network is one where binary weight values (e.g., +1/−1) are applied to a data set instead of, for example, floating-point weight values. BNNs save storage space and computational resources compared to floating-point neural networks. This efficiency allows deep models to run on resource-limited devices. Binary convolution is a technique that is used within BNNs that involves performing binary convolution on binary data. Hardware accelerators may be used to further improve the performance of a BNN such as by offloading binary convolution operations from the CPU to a hardware accelerator.

Unfortunately, hardware accelerators can have a high production cost as they take up more area and result in a complex programming model.

### SUMMARY

Technology is disclosed herein that provides a low cost, low power, and low latency solution for accelerating binary convolutions within a neural network. In various implementations, a binary convolution instruction is added to an instruction set architecture (ISA) of a general-purpose CPU to perform a binary convolution operation on data, rather than having to offload the operations to a hardware accelerator.

In one example implementation, a processing device includes a set of destination registers, binary convolution circuitry, a decoder coupled to the binary convolution circuitry, and instruction fetch circuitry coupled to the decoder and configured to fetch a binary convolution instruction from an associated memory. The binary convolution instruction specifies a set of input data, a set of weight data, and the set of destination registers for performing a binary convolution operation. The instruction fetch circuitry provides fetched instructions to the decoder. The decoder receives the binary convolution instruction from the instruction fetch circuitry to cause the set of input data and the set of weight data specified by the binary convolution instruction to be provided to the binary convolution circuitry. In response, the binary convolution circuitry performs the binary convolution operation on the set of input data and the set of weight data to produce a set of output data and causes the set of output data to be stored in the set of destination registers.

In another example implementation, the decoder decodes the binary convolution instruction to identify the register(s) which store the set of input data and the set of weight data for the binary convolution operation. Further, the binary convolution instruction identifies the set destination register(s) for storing the set of output data generated by the binary convolution operation.

In an implementation, the binary convolution circuitry disclosed herein may include various channels, each of which includes a bit-wise exclusive-nor (XNOR) circuit, a counter circuit such as a population count (POPCOUNT) circuit (e.g., a circuit configured to count the number of 1s or 0s in a data word), and an accumulator circuit. In an implementation, the input data for the binary convolution operation includes multiple data elements such that the XNOR circuit of each of the channels calculates an XNOR of a different combination of two of the multiple data elements relative to the XNOR circuit of each other of the channels. The POPCOUNT circuit of each of the channels performs a POPCOUNT on a result of the XNOR circuit of each of the channels, and the accumulator circuit adds the result of the POPCOUNT circuit of each of the channels to a destination register.

In an embodiment, the input data for the binary convolution operation includes three data elements, such that the XNOR circuit of a first one of the channels calculates an XNOR of a first one of the three data elements with a third one of the three data elements, and outputs a first result. In addition, the POPCOUNT circuit of the first one of the channels performs a POPCOUNT on the first result and outputs a second result. The accumulator circuit of the first one of the channels adds the second result to the destination register.

Next, the XNOR circuit of a second one of the channels calculates an XNOR of a second one of the three data elements and the third one of the three data elements, and outputs a third result. The POPCOUNT circuit of the second one of the channels performs a POPCOUNT on the third result and outputs a fourth result. The accumulator circuit of the second one of the channels adds the fourth result to the destination register. The second result and the fourth result represent an output of the binary convolution operation. In addition, the output of the binary convolution operation is stored within a register file of the processing device.

In an implementation, the binary data values disclosed herein include sensor data associated with a machine learning model, binary weight values of the machine learning model, and output values produced by a layer of the machine learning model.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates a processing system in an implementation.

FIG. 2 illustrates a method of operating a processing system in an implementation.

FIG. 3 illustrates an operational environment in an implementation.

FIG. 4 illustrates an operational sequence in an implementation.

FIG. 5 illustrates an operational architecture in an implementation.

FIG. 6 illustrates another operational architecture in an implementation.

FIG. 7 illustrates another operational architecture in an implementation.

FIG. 8 illustrates a computing system suitable for implementing the various operational environments, architectures, processes, scenarios, and sequences discussed below with respect to the other Figures.

### DETAILED DESCRIPTION

Systems, methods, and devices are disclosed herein which accelerate the binary convolution operations of a neural network without having to offload them to a dedicated hardware accelerator. Rather, a binary convolution instruction is disclosed that may be directly decoded and executed by a general-purpose CPU. The disclosed technique(s) may be implemented in the context of hardware, software, firmware, or a combination thereof to provide a method of acceleration that reduces the power consumption, cost, and latency of a system that executes binary convolutions. In various implementations, a suitable computing system employs binary convolution circuitry via a binary convolution instruction to execute the binary convolution operations of a neural network.

In an embodiment, processing circuitry described herein includes binary convolution circuitry, a decoder coupled to the binary convolution circuitry, and instruction fetch circuitry coupled to the decoder and configured to fetch a binary convolution instruction from an associated memory. The binary convolution instruction is representative of a coded input, indicative of the operation to be performed by the corresponding circuitry. In an implementation the binary convolution instruction is also indicative of the location of the data for the binary convolution. For example, the binary convolution instruction may contain the register addresses of the registers that store the binary data values and binary weights values, as well as the register addresses of the destination register that store the results of the binary convolution. In operation, the instruction fetch circuitry fetches a binary convolution instruction from the associated memory and delivers the fetched instruction to the decoder. The decoder decodes the binary convolution instruction to identify the type of operation to be performed and the location of the data required to perform the operation.

In an implementation, the processing circuitry contains multiple data paths to execute the operations of a neural network. For example, the multiple data paths may include an arithmetic logic data path, a floating-point data path, and a binary convolution data path. In operation the decoder will receive instructions related to the three data paths. In response, the decoder decodes the instruction to identify the appropriate data path to provide the instruction. The decoder also decodes the instruction to identify the location of the data. For example, the decoder may identify the register addresses of the registers that store the data required to perform the instruction. Once the decoder identifies both the appropriate data path and the register addresses of the data, the decoder provides the register addresses to the appropriate data path.

For example, the decoder may provide the register addresses for registers storing data identified by a binary convolution instruction to the binary convolution data path. In response, the binary convolution data path performs the binary convolution operation on the data identified by the binary convolution instruction via binary convolution circuitry.

In an embodiment the binary convolution circuitry of the binary convolution data path includes a plurality of hardware channels such that each of the plurality of channels includes an exclusive-nor (XNOR) circuit, a counter circuit, and an accumulation circuit. In an implementation the counter circuit describes a POPCOUNT circuit. In operation, the decoder provides the register location of the data identified by the binary convolution instruction to the binary convolution data path. In response, the binary convolution data path performs the binary convolution operation on the data identified by the binary convolution instruction. It should be noted, to allow the binary convolution circuitry to perform, the data identified by the binary convolution instruction must be comprised of binary values (such that +1 is encoded as bit 1 and −1 is encoded as bit 0). The output of the binary convolution operation is sent to a destination register of the processing circuitry, as identified by the binary convolution instruction.

Results of the binary convolution operation may be representative of the input to a next node of the network. Meaning, results of the binary convolution operation may be used as input for a future operation of the neural network. Alternatively, results of the binary convolution operation may be representative of the overall output of the neural network.

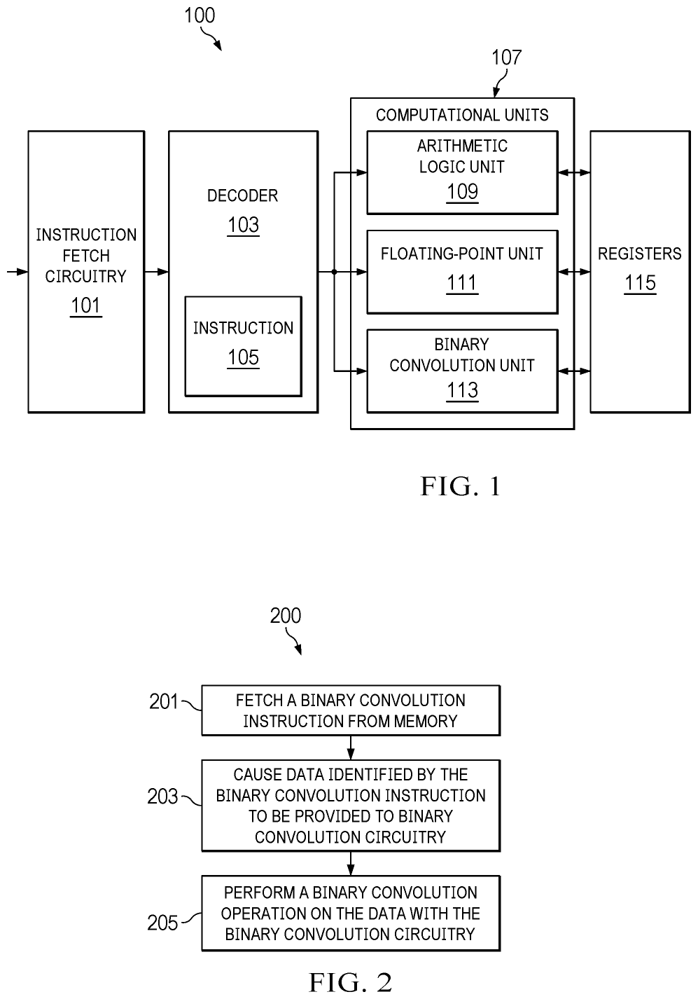

Turning now to the Figures, FIG. 1 illustrates a processing system for executing binary convolution instructions, herein referred to as processing system 100. Processing system 100 is representative of a processor that may be implemented within a single processing device or distributed across multiple processing devices or sub-systems that cooperate in executing program instructions. Examples of processing system 100 include one or more general purpose central processing units. In an implementation, processing system 100 is representative of the Arm Cortex M33 core processor. Processing system 100 includes—but is not limited to—instruction fetch circuitry 101, decoder 103, computational units 107, and registers 115. Instruction fetch circuitry 101, decoder 103, computational units 107, and registers 115 may be integrated into a single integrated circuit chip or implemented as multiple interconnected chips. Processing system 100 may be implemented in a larger context, such as, for example, a computer vision system.

Instruction fetch circuitry 101 is representative of circuitry that fetches instructions (e.g., instruction 105), from an associated program memory (not shown) and provides the instructions to decoder 103. Instruction fetch circuitry 101 may include components such as address and data busses, an instruction cache, and a control unit. Instruction fetch circuitry 101 may include circuitry types such as sequential fetch circuitry, prefetching circuitry, branch prediction circuitry, or trace cache circuitry.

Decoder 103 is representative of a multi-input, multi-output logic circuit that converts coded input into readable output signals. Decoder 103 is coupled to computational units 107 to deliver instructions for a neural network to execute an operation. In an implementation, decoder 103 is also coupled to instruction fetch circuitry 101 to receive instructions related to computational units 107. In operation, decoder 103 receives instruction 105 from instruction fetch circuitry 101 and stores instruction 105 to an instruction buffer (not shown). Next, decoder 103 decodes instruction 105 to identify the location of the data (e.g., operands) that instruction 105 is to operate on. In an implementation, instruction 105 specifies one or more register addresses that store the data for performing instruction 105. For example, the data used to perform instruction 105 may be stored in registers 115. Alternatively, data used to perform instruction 105 may be stored in a register file of an off-chip memory.

Instruction 105 also specifies the operation to be performed on the data. Instruction 105 may be representative of three types of operations including an arithmetic logic operation, a floating-point operation, or a binary convolution operation. In an implementation, instruction 105 specifies both the operation to be performed, as well as the registers which store the data. For example, instruction 105 may be representative of a binary convolution instruction that employs BCU 113 to perform a binary convolution operation on data stored by registers 115.

In an implementation, the registers specified by instruction 105 are representative of the registers that store the input data, the weight data, and the output data. Input data may be representative of data collected by a sensor, such as image data, acoustic data, vibration data, current data, voltage data, or a combination thereof. Alternatively, input data may be representative of computational data produced by a previous node of the network. Weight data is representative of the weight values applied to the input data by the nodes of the network. Output data is representative of the output produced by computational units 107. As such, instruction 105 identifies the destination register for storing the output data. In an implementation the data identified by instruction 105 is stored by registers 115. In another implementation the data is stored by a memory associated with processing system 100. In operation, decoder 103 identifies the register address(es) of the data for performing instruction 105 and loads the register address(es) of the data to the appropriate computational unit.

Computational units 107 are representative of the different data paths available in a processor for processing data. Computational units 107 include—but are not limited to—arithmetic logic unit (ALU) 109, floating-point unit (FPU) 111, and binary convolution unit (BCU) 113. ALU 109 is representative of a component that executes arithmetic and bitwise operations on fixed-point numbers. ALU includes circuitry configured to perform operations on operands such as simple addition and subtraction, as well as logic operations such as AND and OR. FPU 111 is representative of a component designed to carry out operations on floating point numbers. Example operations include multiply, divide, and square root. Finally, BCU 113 is representative of a component that executes binary convolution operations on binary data.

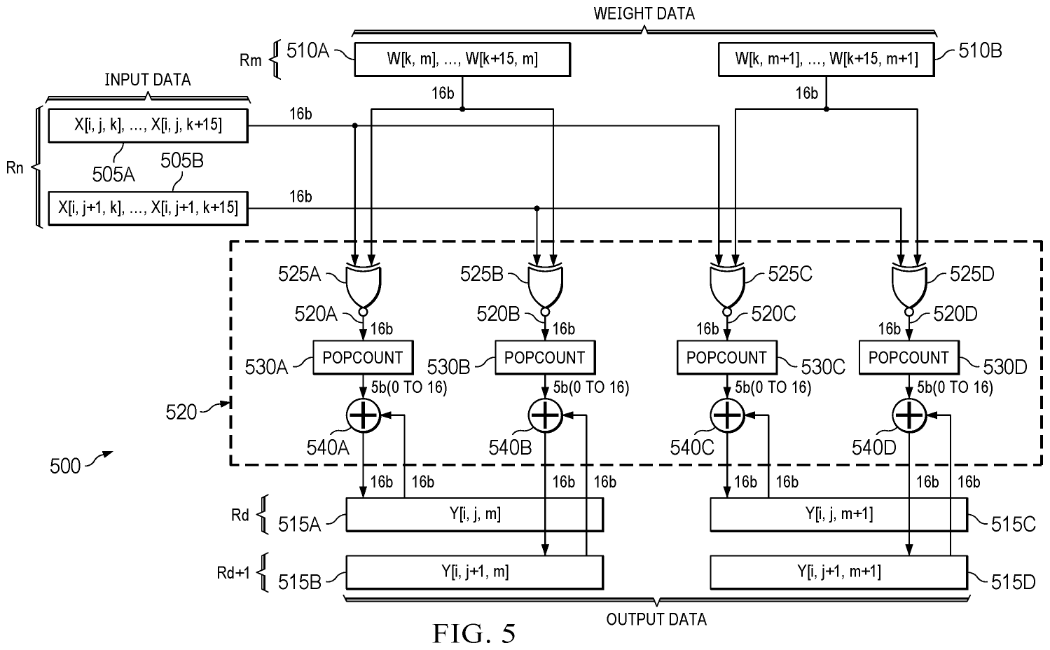

In an implementation BCU 113 includes circuitry, specifically designed to perform binary convolutions. In operation, decoder 103 receives an instruction from instruction fetch circuitry 101 for a binary convolution operation, herein referred to as a binary convolution instruction (BCI). Decoder 103 decodes the BCI to determine the register addresses that store the data for the binary convolution operation. For example, the BCI may be indicative of the registers which store the binary data values and the binary weigh values for the binary convolution operation. Further, the BCI may be indicative of the address of the destination register which the output of the binary convolution operation is loaded to. Decoder 103 loads the identified register addresses to BCU 113 to cause BCU 113 to perform the binary convolution operation on the data stored by the registers identified by decoder 103. BCU 113 performs the binary convolution operation via binary convolution circuitry and outputs the results to the destination register. In an implementation the destination register is located in registers 115. Operational architectures 500, 600, and 700 of FIGS. 5-7 respectively are representative of such binary convolution circuitry.

Registers 115 are representative of register files used to store computational data of a neural network. Computational data of registers 115 may include input data collected by an associated system, output data produced by computational units 107, or weight data employed by the neural network.

In operation, decoder 103 receives instruction 105 from instruction fetch circuitry 101 to determine the operation to be performed. Next decoder 103 decodes instruction 105 to identify the registers which store the data. For example, instruction 105 may identify the register addresses for the registers which store the input data and the weight data as well as the destination register that will store the output data. Upon decoding instruction 105, decoder 103 signifies to the appropriate computational unit the register addresses of the data for executing the operation of instruction 105. Instructions related to arithmetic operations are executed by ALU 109. Instructions related to floating-point operations are executed by FPU 111. Instructions related to binary convolution operations are executed by BCU 113.

Upon receiving the decoded instruction, the corresponding computational unit performs the operation of the decoded instruction. Results of computational units 107 are stored by registers 115. In an implementation, results of the computational units 107 are representative of the input to a next node of the neural network. In another implementation results of computational units 107 represent the overall output of the neural network.

FIG. 2 illustrates a method of operating processing system 100 in an implementation, herein referred to as method 200. To begin, the method includes fetching a binary convolution instruction from memory (step 201) and loading the instruction to a decoder. The binary convolution instruction may be fetched by instruction fetch circuitry from an on-chip memory or an off-chip memory. The binary convolution instruction includes an opcode and an operand. The opcode specifies the operation to be performed, while the operand specifies the location of the data on which the operation is to be performed. Here, the opcode of the binary convolution instruction specifies to the decoder that a binary convolution is to be performed on data located in the registers specified by the register addresses of the operand. Data specified by the operand includes input data and weight data. Further, the operand specifies the register address for the destination register. The destination register stores the output of the binary convolution.

In an implementation, the decoder decodes the instruction to identify the register locations of the data for the operation of the instruction. The decoder provides the decoded instruction to a binary convolution unit. In response the binary convolution unit causes the data specified by the operand to be provided to binary convolution circuitry of the binary convolution unit (step 203). For example, the binary convolution unit may locate the registers identified by the decoder. Registers identified by the decoder and located by the binary convolution unit include an input register, a weight register, and a destination register.

Upon locating the data identified by the binary convolution instruction, the method continues with the binary convolution unit performing a binary convolution operation on the data via the binary convolution circuitry (step 205). In an implementation, the binary convolution circuitry includes multiple channels configured to perform the binary convolution operation. For instance, each one of the channels includes an exclusive-nor (XNOR) circuit, a POPCOUNT circuit, and an accumulator circuit. To perform the binary convolution operation, the binary convolution circuitry convolves the data stored in the input register with weight values stored in the weight register. Weight values stored in the weight register are representative of binary values, generated during the training stage of the neural network. Output of the binary convolution operation is stored in the destination register. Data loaded to the destination register may be representative of input to a next node of the neural network, or the overall output of the neural network.

Referring back to FIG. 1, the following describes a brief example of process 200 applied in the context of processing system 100. To begin, instruction fetch circuitry 101 fetches instruction 105 from an associated memory and feeds instruction 105 to decoder 103. Decoder 103 receives instruction 105 from instruction fetch circuitry 101 such that instruction 105 is representative of a binary convolution instruction. Next, decoder 103 decodes instruction 105 to identify the operation to be performed, as well as the register location of the data for the operation.

Upon decoding the instruction, decoder 103 loads the decoded instruction to BCU 113. In response, BCU 113 causes the data identified by the decoded instruction to be provided to binary convolution circuitry of BCU 113, such that the binary convolution circuitry performs a binary convolution operation on the provided data.

To perform the binary convolution operation, the binary convolution circuitry convolves different elements of the data. For example, the data may include input data as well as weight data, such that the input data is convolved with the weight data. Output of the binary convolution operation is stored within registers 115. In an implementation, data of registers 115 represents input to a next node of the neural network. In another implementation, data of registers 115 represents the overall output of a neural network.

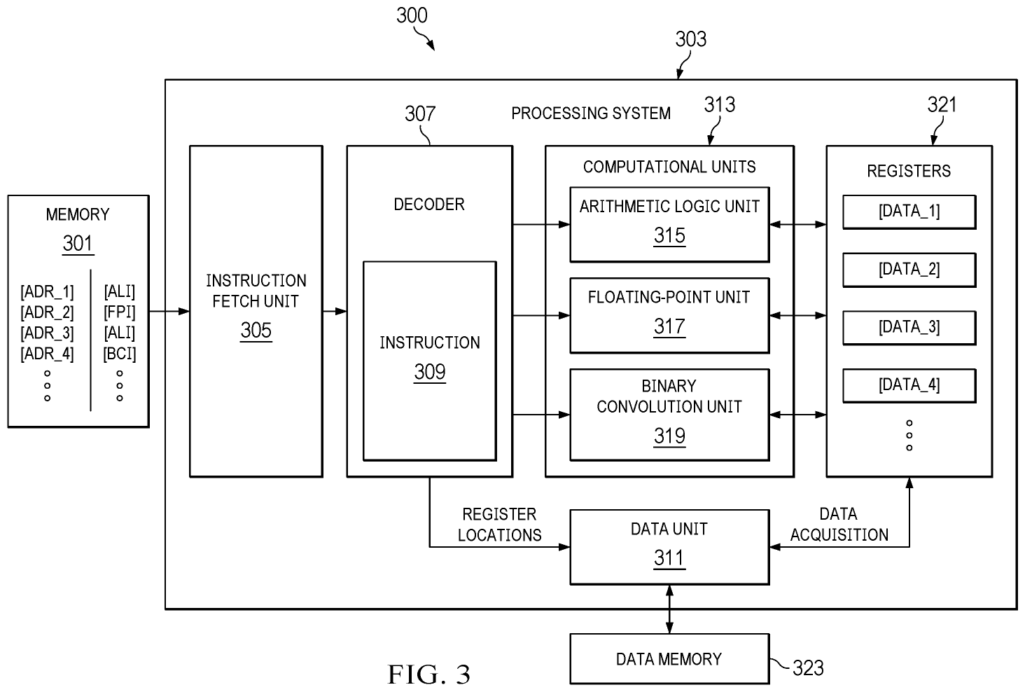

FIG. 3 illustrates an operational environment in an implementation, herein referred to as operational environment 300. Operational environment 300 is representative of a system used in the context of neural networks to execute a task. For example, such tasks may include object detection, image classification, and so on. Operational environment 300 includes program memory 301, processing system 303, and data memory 323. Operational environment 300 may be implemented in a larger context, such as, any system that utilizes computer vision.

Program memory 301 is representative of an on-chip or off-chip memory accessed by processing system 303. In this case, program memory 301 serves as fast access memory for processing system 303 and is logically coupled to instruction fetch unit 305 to load instructions required by processing system 303 to execute operations of a neural network. Program memory 301 stores instructions related to arithmetic operations, floating-point operations, and binary convolution operations. Example instructions include arithmetic logic instructions (ALIs), floating-point instructions (FPIs), and binary convolution instructions (BCIs). In an implementation, program memory 301 also stores the register addresses of the data required to perform the operations.

Processing system 303 is representative of a general-purpose central processing unit capable of executing program instructions. For example, processing system 303 may be representative of processing system 100 of FIG. 1. Processing system 303 includes—but is not limited to—instruction fetch unit 305, decoder 307, data unit 311, computational units 313, and registers 321. In some examples, processing system 303 is an implementation of processing system 100, and instruction fetch unit 305 may be substantially similar to instruction fetch circuitry 101. Decoder 307 may be substantially similar to decoder 103. Computational units 313 may be substantially similar to computational units 107. Registers 321 may be substantially similar to registers 115. Processing system 303 may be implemented within a single processing device but may also be distributed across multiple processing devices or sub-systems that cooperate in executing program instructions.

Instruction fetch unit 305 is representative of circuitry configured to load instructions from program memory 301 to decoder 307. In operation, instruction fetch unit 305 fetches an instruction from program memory 301. For example, instruction fetch unit 305 may fetch instruction 309 from program memory 301. Instruction fetch unit 305 delivers instruction 309 to decoder 307 to begin execution.

Decoder 307 is representative of a logic circuit that converts coded inputs into output signals that are readable by computational units 313. In an implementation, decoder 307 includes an instruction buffer (not shown) to store instructions loaded from program memory 301. For example, decoder 307 may receive instruction 309 from instruction fetch unit 305. Instruction 309 may be representative of either an ALI, an FPI, or a BCI. Decoder 307 decodes instruction 309 to determine the appropriate computational unit for the indicated operation. For example, instruction 309 may be representative of a BCI that employs BCU 319 to perform a binary convolution operation on data stored by registers 321.

In an implementation, decoder 307 also decodes instruction 309 to determine the location of the data for instruction 309. For example, instruction 309 may be indicative of the addresses of the registers (e.g., registers 321) which store the data for the operation of instruction 309. In an implementation, decoder 307 sends the decoded register addresses to data unit 311. In response data unit 311 allows the appropriate computational unit to access the data.

Data unit 311 is representative of circuitry configured to provide data for computational units 313. Data unit 311 receives the register locations for the data from decoder 307. In response, data unit 311 will allow the appropriate computational unit to access the registers storing the data to begin execution by obtaining the data from either registers 321 or data memory 323, dependent on where the data is stored.

Data memory 323 is representative of an on-chip or off-chip memory accessed by processing system 303 (e.g., a cache). In this case, data memory 323 serves as fast access memory for processing system 303 and is logically coupled to data unit 311. In an implementation, data memory 323 stores the data for performing operations by computational units 313. For example, data memory 323 includes register files which store data that is not stored by registers 321.

Computational units 313 are representative of the different data paths used to execute the instructions of program memory 301. Computational units 313 include arithmetic logic unit (ALU) 315, floating-point unit (FPU) 317, and binary convolution unit (BCU) 319. ALU 315 is representative of a component that executes arithmetic and bitwise operations on binary numbers. ALU 315 includes circuitry configured to perform operations on operands such as simple addition and subtraction, as well as logic operations such as AND and OR. FPU 317 is representative of a component designed to carry out operations on floating point numbers. Example operations include multiply, divide, and square root. Finally, BCU 319 is representative of a component that executes binary convolution operations via circuitry configured to perform binary convolutions with respect to a BCI's operands. In an implementation, BCU 319 includes circuitry of which operational architectures 500, 600, and 700 of FIGS. 5-7 are representative of.

Registers 321 represent register files which store computational data of a neural network. Computational data of registers 321 may include input data collected by an associated system, output data produced by computational units 313, or weight data employed by the neural network.

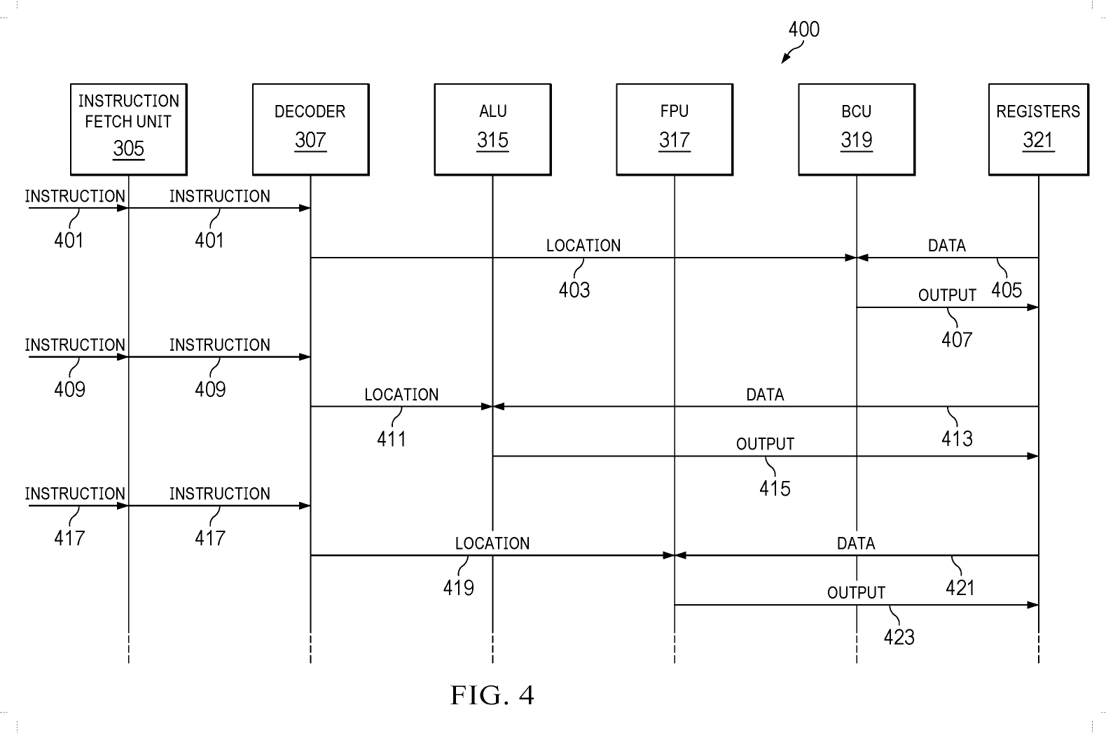

FIG. 4 illustrates an operational sequence for executing a binary convolution instruction, herein referred to as operational sequence 400. Operational sequence 400 demonstrates how the components of operational environment 300 execute instructions related to a neural network. Operational sequence 400 includes instruction fetch unit 305, decoder 307, arithmetic logic unit (ALU) 315, floating-point unit (FPU) 317, binary convolution unit (BCU) 319, and registers 321.

In operation, instruction fetch unit 305 fetches instruction 401 from program memory 301 and delivers instruction 401 to decoder 307. Decoder 307 receives instruction 401 and decodes the opcode of instruction 401 to identify the appropriate computational unit to execute instruction 401. Further, decoder 307 decodes the operand of instruction 401 to identify the location of the registers for the operation of instruction 401. In an implementation, the operand of instruction 401 identifies the address(es) of the register(s) (i.e., registers 321) that stores the data for the operation.

Upon decoding instruction 401, decoder 307 supplies location 403 to the appropriate computational unit. As illustrated, decoder 307 supplies location 403 to BCU 319. In response BCU 319 accesses data 405 from registers 321. Data 405 represents the binary values for a binary convolution operation, such that the binary values include the binary weight values and the binary input values. Upon accessing the necessary data, binary convolution circuitry of BCU 319 performs the binary convolution operation on data 405 to generate output 407. BCU 319 sends output 407 to a destination register of registers 321 to be stored.

The remainder of operational sequence 400 illustrates how other program instructions associated with ALU 315 and FPU 317 are handled. For example, instruction fetch unit 305 fetches instruction 409 from program memory 301 and delivers instruction 409 to decoder 307. Decoder 307 receives instruction 409, representative of an instruction corresponding to ALU 315. Thus, it is assumed for exemplary purposes that instruction 409 includes an opcode corresponding to an operation of ALU 315. Upon receiving instruction 409, decoder 307 supplies the location of the data identified by an operand of instruction 409 to ALU 315. ALU 315 receives location 411 which causes ALU 315 to access data 413 from registers 321. Data 413 represents the values for performing an operation by ALU 315. Accordingly, ALU 315 performs the operation specified by instruction 409 on data 413 to generate output 415, which is stored by a destination register within registers 321.

In another example, instruction fetch unit 305 fetches instruction 417 from program memory 301 and delivers instruction 417 to decoder 307. Decoder 307 receives instruction 417 representative of an instruction corresponding to FPU 317. Thus, it is assumed for exemplary purposes that instruction 417 includes an opcode corresponding to an operation of FPU 317. Upon receiving instruction 417, decoder 307 supplies the location of the data identified by an operand of instruction 417 to FPU 317. FPU 317 receives location 419 which causes FPU 317 to access data 421 from registers 321. Data 421 represents the values for performing an operation by FPU 317. Accordingly, FPU 317 performs the operation specified by instruction 417 on data 421 to generate output 423, which is stored by registers 321.

FIG. 5 illustrates an operational architecture suitable for executing a binary convolution instruction, herein referred to as operational architecture 500. Operational architecture 500 may be implemented in a larger context such as processing system 100 or operational environment 300, such that operational architecture 500 is included in BCU 113 or BCU 319. Operational architecture 500 includes multiple input registers, as well as circuit 520. When invoked by the binary convolution instruction, operational architecture 500 performs a binary convolution operation via circuit 520 on data elements stored by the input registers. An exemplary instruction has the following form: CX3DA {cond}, <coproc>, <Rd>, <Rd+1>, <Rn>, <Rm>, #<imm>.

In the definition above, “CX3DA” represents an opcode reserved for custom instructions in the Arm® Cortex® instruction set and is recognizable by a decoder. In this example, “CX3DA” is used to perform any of a class of operations outside of the Arm® Cortex® instruction set that are defined by the implementing device. The particular operation to be performed is specified by the field #<imm>. In an implementation, the CX3DA instruction accepts up to seven parameters. The parameter “{cond}” may be used to specify a condition code to make execution of the instruction conditional, and the parameter “<coproc>” specifies a processing resource (e.g., binary convolution unit 113 and/or binary convolution unit 319) to perform the instruction. The next four parameters, “<Rd>”, “<Rd+1>”, “<Rn>”, and “<Rm>”, are representative of the operands for performing the opcode of instruction CX3DA. More specifically, “<Rd>” and “<Rd+1>” represent the register locations for storing the output data elements, “<Rn>” represents the register location that stores the feature data elements, and “<Rm>” represents the register location that stores the weight data elements. In an implementation, “<Rn>” and “<Rm>” registers are interchangeable. The final parameter, “#<imm>”, is an immediate value that specifies the operation to be performed on the data elements stored by the operands. For example, “#<imm>” may indicate that a binary convolution operation is to be performed on the data elements stored by the registers corresponding to “<Rn>” and “<Rm>” such that output of the binary convolution operation is stored by the destination registers corresponding to “<Rd>” and “<Rd+1>”.

The input registers of operational architecture 500 are representative of registers, stored in a register file (i.e., registers 115 and registers 321) associated with circuit 520. In an implementation the input registers include feature/weight/Rn registers, weight/feature/Rm registers, and output/Rd/Rd+1 registers, such that each of the input registers is configured to store different data elements. For example, data elements stored by register 505A and register 505B may include the feature data for circuit 520. In an implementation, the feature data elements stored by registers 505A and 505B include feature vectors corresponding to image data, acoustic data, vibration data, current data, voltage data, or a combination thereof, collected by a sensor associated with circuit 520. In an example, data register 505A stores a set of 16 1-bit data elements of a three dimensional array (e.g., elements X[i, j, k] through X[i, j, k+15]), and data register 505B stores 16 1-bit data elements of an adjacent row or column in the array (e.g., X[i, j+1, k] through X[i, j+1, k+15]). Values stored by register 510A and register 510B may include the binary weight data for circuit 520. In an example, register 510A stores 16 1-bit weights (weights k through k+15) of a first set of weights (W[m]), and register 510B stores 16 1-bit weights (weights k through k+15) of a second set of weights (W[m+1]). In an implementation, the weight data elements stored by registers 510A and 510B include binary weight values corresponding to nodes of the associated neural network. Finally, data elements stored by registers 515A-D include the output of the binary convolution operation. In an example, registers 515A and 515C each store 16 bits of an output data element, Y[i, j, m] and Y[i, j, m+1], respectively. In the example, registers 515B and 515D each store 16 bits of an output data element, Y[i, j+1, m] and Y[i, j+1, m+1], respectively. As such, registers 515A-D are representative of the <Rd> and <Rd+1>.

In an implementation, a decoder associated with operational architecture 500 receives the binary convolution instruction. The decoder decodes the instruction to identify the location of the registers storing the data elements specified for the instruction. Upon decoding the instruction, an associated unit (i.e., data unit 311) allows circuit 520 to access the data elements for the binary convolution instruction. Meaning, circuit 520 may now access the data elements stored by the associated register file such that the associated register file includes register 505A, register 505B, register 510A, and register 510B. Further circuit 520 may now access the destination registers of the associated register file such that circuit 520 outputs binary convolution results to register 515A, register 515B, register 515C, and register 515D of the associated register file. In an implementation, outputs stored in the destination registers are later used as input to a next operation of the neural network.

Circuit 520 includes multiple hardware channels (520A, 520B, 520C, and 520D) used to perform the binary convolution operation. Each channel is implemented by a specific sub-circuit of circuit 520. Each one of the channels includes an exclusive-nor (XNOR) circuit (e.g., a multi-bit XNOR circuit), a POPCOUNT circuit, and an accumulator circuit. The XNOR circuit of each of the channels calculates a bit-wise XNOR of a different combination of two of the multiple data elements relative to the XNOR circuit of each-other of the channels. In addition, the POPCOUNT circuit of each of the channels performs a POPCOUNT (e.g., a count of 1's or 0's in a set of data elements) on a result of the XNOR circuit of each of the channels.

Specifically, the input to XNOR circuit 525A of channel 520A includes the feature data elements of register 505A and the weight data elements of register 510A. In an implementation register 505A and register 510A are representative of 32-bit registers. As such, XNOR circuit 525A is representative of 16 separate XNOR gates. In operation, XNOR circuit 525A performs a bit-wise XNOR on the data elements of register 505A with the data elements of register 510A to produce an output. Output of XNOR circuit 525A is passed to POPCOUNT circuit 530A. In an implementation the output of POPCOUNT circuit 530A is representative of a five-bit output which indicates the number of ones in the output of XNOR circuit 525A. The output of POPCOUNT circuit 530A is fed to accumulator circuit 540A, which adds the output to a current value in register 515A. The sum is then written to register 515A.

The input to XNOR circuit 525B of channel 520B includes the feature data elements of register 505B and the weight data elements of register 510A, and the output of XNOR circuit 525B feeds into POPCOUNT circuit 530B. The output of POPCOUNT circuit 530B is fed to accumulator circuit 540B which adds the output to a current value in register 515B. The new sum is then written to register 515B.

The input to XNOR circuit 525C of channel 520C includes the feature data elements of register 505A and the weight data elements of register 510B, and the output of XNOR circuit 525C feeds into POPCOUNT circuit 530C. The output of POPCOUNT circuit 530C is fed to accumulator circuit 540C which adds the output to a current value in register 515C. The new sum is then written to register 515C.

The input to XNOR circuit 525D of channel 520D includes the feature data elements of register 505B and the weight data elements of register 510B, and the output of XNOR circuit 525D feeds into POPCOUNT circuit 530D. The output of POPCOUNT circuit 530D is fed to accumulator circuit 540D which adds the output to a current value in register 515D. The new sum is then written to register 515D.

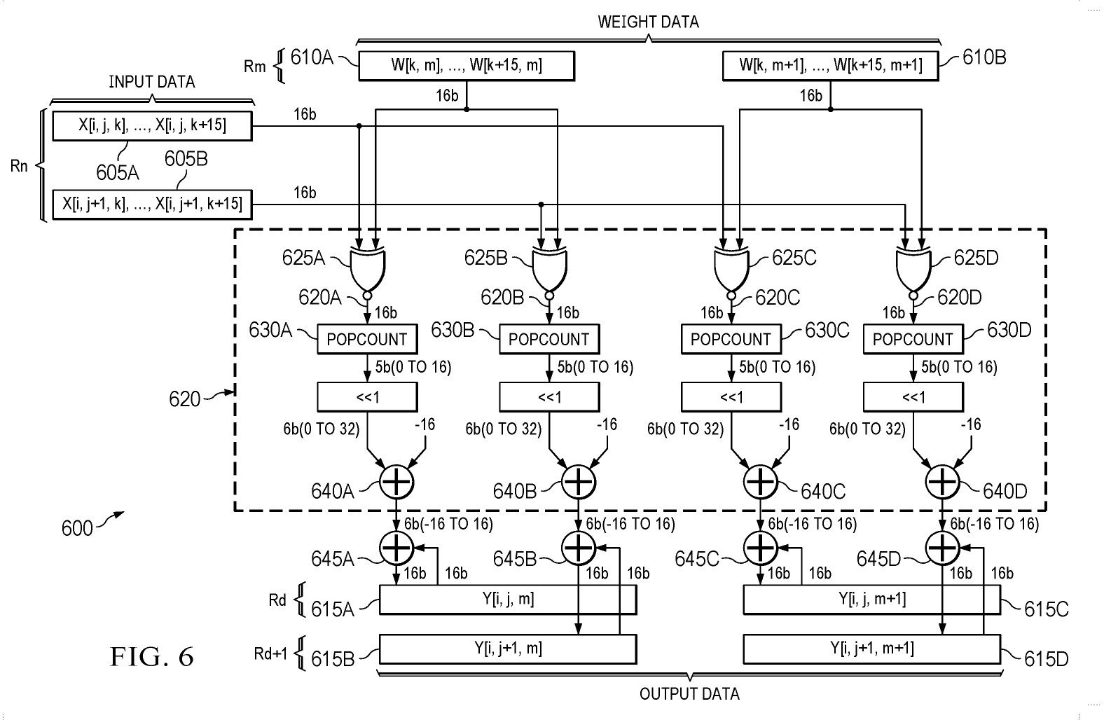

FIG. 6 illustrates another operational architecture suitable for executing a binary convolution instruction, herein referred to as operational architecture 600. Operational architecture 600 differs from operational architecture 500 in FIG. 5 in that it (operational architecture 600) performs a “true” binary convolution operation to obtain binary convolution results. In contrast, operational architecture 500 performs operations that generate binary convolution results. Meaning, both architectures yield the same results, but approach the operations differently. Operational architecture 600 may be implemented in a larger context such as processing system 100 or operational environment 300, such that operational architecture 600 is housed by BCU 113 or BCU 319.

Operational architecture 600 includes multiple input registers, as well as circuit 620. When invoked by the binary convolution instruction, operational architecture 600 performs a binary convolution operation via circuit 620 on the data elements stored by the input registers. An exemplary instruction is again defined as follows: CX3DA {cond}, <coproc>, <Rd>, <Rd+1>, <Rn>, <Rm>, #<imm>, such that “#<imm>” represents the opcode, while “<Rd>”, “<Rd+1>”, “<Rn>”, and “<Rm>” are representative of the operands. More specifically “<Rd>” and “<Rd+1>” are representative of the destination registers which store the output data elements of the binary convolution operation, “<Rn>” represents the register location for the feature data elements, and “<Rm>” represents the register location for the weight data elements. In an implementation “<Rn>” and “<Rm>” are interchangeable. The input registers of operational architecture 600 are representative of registers, stored in a register file associated with circuit 620. In an implementation the input registers include feature/weight/Rn registers, weight/feature/Rm registers, and output/Rd/Rd+1 registers, such that each of the input registers is configured to store different data elements. For example, data elements stored by register 605A and register 605B may include the feature data for circuit 520. Alternatively, data elements stored by register 610A and register 610B may include the binary weight data for circuit 620. Finally, data elements stored by registers 615A-D include the output of the binary convolution operation. As such, registers 515A-D are representative of the <Rd> and <Rd+1>.

In an implementation, a decoder associated with operational architecture 600 receives the binary convolution instruction. The decoder decodes the instruction to identify the location of the registers storing the data elements for the binary convolution instruction. Upon decoding the instruction, an associated unit allows circuit 620 to access the data elements. Meaning, circuit 620 may now access the data elements stored by the associated register file such that the associated register file stores register 605A, register 605B, register 610A, and register 610B. Further circuit 620 may now access the destination registers of the associated register file such that circuit 620 outputs binary convolution results to register 615A, register 615B, register 615C, and register 615D of the associated register file. In an implementation, outputs stored in the destination registers are later used as input to a next operation of the neural network.

Circuit 620 includes multiple hardware channels (620A, 620B, 620C, and 620D) used to perform the binary convolution operation. Each channel is implemented by a specific sub-circuit of circuit 620. Each one of the channels includes an exclusive-nor (XNOR) circuit, a POPCOUNT circuit, a first accumulator circuit, and a second accumulator circuit. The XNOR circuit of each of the channels calculates a bit-wise XNOR of a different combination of two of the multiple data elements relative to the XNOR circuit of each-other of the channels. In addition, the POPCOUNT circuit of each of the channels performs a POPCOUNT on a result of the XNOR circuit of each of the channels.

Specifically, the input to XNOR circuit 625A of channel 620A includes the feature data elements of register 605A and the weight data elements of register 610A, and the output of XNOR circuit 625A feeds into POPCOUNT circuit 630A. The output of POPCOUNT circuit 630A is fed to logic that shifts the output to the left by one. This operation is equivalent to multiplying the output of POPCOUNT circuit 630A by two. The output of the logic is passed to first accumulator circuit 640A, which subtracts 16 from the output. The output of first accumulator circuit 640A is passed to second accumulator circuit 645A, which adds the output to a current value in register 615A. The sum is then written to register 615A.

The input to XNOR circuit 625B of channel 620B includes the feature data elements of register 605B and the weight data elements of register 610A, and the output of XNOR circuit 625B feeds into POPCOUNT circuit 630B. The output of POPCOUNT circuit 630B is fed to logic that shifts the output to the left by one. This operation is equivalent to multiplying the output of POPCOUNT circuit 630B by two. The output of the logic is passed to first accumulator circuit 640B, which subtracts 16 from the output. The output of first accumulator circuit 640B is passed to second accumulator circuit 645B, which adds the output to a current value in register 615B. The sum is then written to register 615B.

The input to XNOR circuit 625C of channel 620C includes the feature data elements of register 605A and the weight data elements of register 610B, and the output of XNOR circuit 625C feeds into POPCOUNT circuit 630C. The output of POPCOUNT circuit 630C is fed to logic that shifts the output to the left by one. This operation is equivalent to multiplying the output of POPCOUNT circuit 630C by two. The output of the logic is passed to first accumulator circuit 640C, which subtracts 16 from the output. The output of first accumulator circuit 640C is passed to second accumulator circuit 645C, which adds the output to a current value in register 615C. The sum is then written to register 615C.

The input to XNOR circuit 625D of channel 620D includes the feature data elements of register 605B and the weight data elements of register 610B, and the output of XNOR circuit 625D feeds into POPCOUNT circuit 630D. The output of POPCOUNT circuit 630D is fed to logic that shifts the output to the left by one. This operation is equivalent to multiplying the output of POPCOUNT circuit 630D by two. The output of the logic is passed to first accumulator circuit 640D, which subtracts 16 from the output. The output of first accumulator circuit 640D is passed to second accumulator circuit 645D, which adds the output to a current value in register 615D. The sum is then written to register 615D.

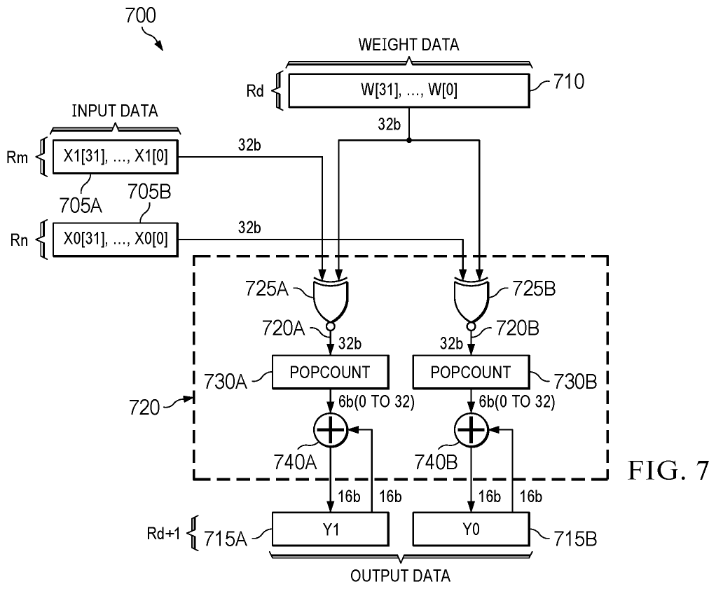

FIG. 7 illustrates another operational architecture suitable for executing a binary convolution instruction, herein referred to as operational architecture 700. Operational architecture 700 may be implemented in a larger context such as processing system 100 or operational environment 300, such that operational architecture 600 is housed by BCU 113 or BCU 319. Operational architecture 700 includes multiple input registers, as well as circuit 720. When invoked by the binary convolution instruction, operational architecture 700 performs a binary convolution operation via circuit 720 on the data elements stored by the destination registers.

An exemplary instruction is again defined as follows: CX3DA {cond}, <coproc>, <Rd>, <Rd+1>, <Rn>, <Rm>, #<imm>, such that “#<imm>” represents the opcode, while “<Rd>”, “<Rd+1>”, “<Rn>”, and “<Rm>” are representative of the operands. However, in a departure from the instruction definitions provided with respect to FIGS. 5 and 6, the <Rm> and <Rn> registers are used for feature data elements, while the <Rd> register is used for weight data elements and the <Rd+1> register is used for output data elements. In an implementation the <Rm> and <Rn> registers are used for weight data elements, while the <Rd> register is used for feature data elements.

For example, register 705A represents the <Rm> register that stores the feature data elements for circuit 720, and register 705B represents the <Rn> register that also stores the feature data elements. Register 710 represents the <Rd> register that stores the weight data elements. While registers 715A and 715B represent an <Rd+1> register which is representative of the destination registers which stores the output data elements of the binary convolution operation. In an implementation registers 705A, 705B, 710, 715A, and 715B are stored in a register file associated with circuit 720.

Circuit 720 includes multiple hardware channels (720A and 720B) used to perform the binary convolution operation. Each channel is implemented by a specific sub-circuit of circuit 720. Each one of the channels includes an exclusive-nor (XNOR) circuit, a POPCOUNT circuit, and an accumulator circuit. The XNOR circuit of each of the channels calculates a bit-wise XNOR of a different combination of two of the multiple data elements relative to the XNOR circuit of each-other of the channels. In addition, the POPCOUNT circuit of each of the channels performs a POPCOUNT on a result of the XNOR circuit of each of the channels.

Specifically, the input to XNOR circuit 725A of channel 720A includes the feature data elements of register 705A and the weight data elements of register 710, and the output of XNOR circuit 725A feeds into POPCOUNT circuit 730A. The output of POPCOUNT circuit 730A is fed to accumulator circuit 740A, which adds the output to a current value in register 715A. The sum is then written to register 715A. The input to XNOR circuit 725B of channel 720B includes the feature data elements of register 705B and the weight data elements of register 710, and the output of XNOR circuit 725B feeds into POPCOUNT circuit 730B. The output of POPCOUNT circuit 730B is fed to accumulator circuit 740B, which adds the output to a current value in register 715B. The sum is then written to register 715B.

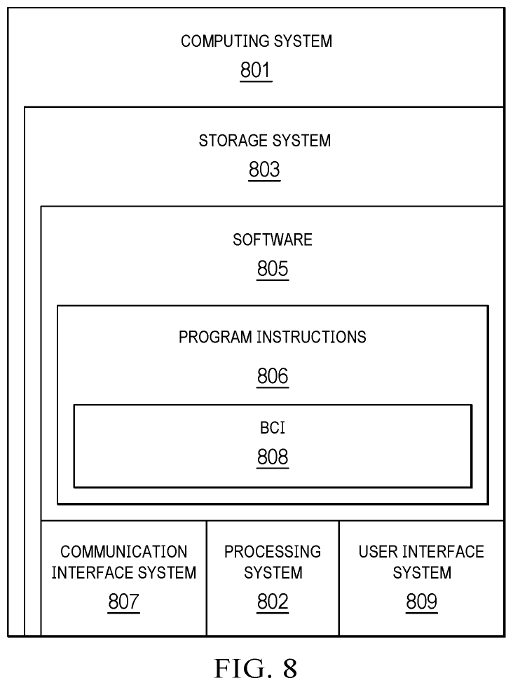

It may be appreciated that the foregoing implementations may be implemented in the context of a variety of computing devices including—but not limited to—embedded computing devices, industrial computers, personal computers, server computers, automotive computers, MCUs, and the like. As such, the technology disclosed herein also contemplates software products produced by compilers capable of generating binary convolution instructions as disclosed herein. That is, the technology disclosed herein includes compiled software programs having binary convolution instructions amongst their program instructions. FIG. 8 illustrates computing device 801, which is representative of such computers.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809 (optional). Processing system 802 is operatively coupled to storage system 803, communication interface system 807, and user interface system 809.

Processing system 802 loads and executes software 805 from storage system 803. Software 805 includes program instructions 806, which includes binary convolution instructions 808. When executed by processing system 802, software 805 directs processing system 802 to operate as described herein for at least the various processes, operational scenarios, and sequences discussed in the foregoing implementations. Computing device 801 may optionally include additional devices, features, or functions not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include one or more general purpose central processing units, graphical processing units, microprocessors, digital signal processors, field-programmable gate arrays, application specific processors, processing circuitry, analog circuitry, digital circuitry, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 is implemented in program instructions 806 and among other functions may, when executed by processing system 802, direct processing system 802 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support binary convolution operations. Indeed, encoding software 805 (and binary convolution instructions 808) on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary, etc.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A processing device comprising:
binary convolution circuitry;
a set of destination registers;
a decoder coupled to the binary convolution circuitry; and
instruction fetch circuitry coupled to the decoder and configured to fetch a binary convolution instruction from memory, wherein the binary convolution instruction specifies a set of input data, a set of weight data, and the set of destination registers;
wherein the decoder is configured to cause the set of input data and the set of weight data to be provided to the binary convolution circuitry; and
wherein the binary convolution circuitry is configured to:
perform a binary convolution operation on the set of input data and the set of weight data to produce a set of output data; and
cause the set of output data to be stored in the set of destination registers.

2. The processing device of claim 1 further comprising a data unit coupled to the binary convolution circuitry, wherein to cause the set of input data and the set of weight data to be provided to the binary convolution circuitry, the decoder is configured to provide register locations identified by the binary convolution instruction to the data unit, wherein the register locations comprise locations for an input data register, a weight data register, and a destination register.

3. The processing device of claim 2, wherein the binary convolution circuitry comprises a plurality of channels, and wherein each of the plurality of channels includes an exclusive-nor (XNOR) circuit, a counter circuit coupled to the XNOR circuit, and an accumulator circuit coupled to the counter circuit.

4. The processing device of claim 3, wherein the data comprises multiple data elements, and wherein the XNOR circuit of each of the channels calculates a bit-wise XNOR of a different combination of two of the multiple data elements relative to the XNOR circuit of each of the other channels, wherein the counter circuit of each of the channels performs a counting operation on a result of the XNOR circuit of each of the channels, and wherein the accumulator circuit adds the output of the counter circuit to the destination register.

5. The processing device of claim 3, wherein the data comprises three data elements, and wherein the XNOR circuit of a first one of the channels calculates an XNOR of a first one of the three data elements and a third one of the three data elements and outputs a first result, and wherein the counter circuit of the first one of the channels performs a counting operation on the first result and outputs a second result, and wherein the accumulator circuit adds the second result to the destination register.

6. The processing device of claim 5, wherein the XNOR circuit of a second one of the channels calculates an XNOR of a second one of the three data elements and the third one of the three data elements, and outputs a third result, wherein the counter circuit of the second one of the channels performs a counting operation on the third result and outputs a fourth result, and wherein the accumulator circuit adds the fourth result to the destination register.

7. The processing device of claim 6, wherein the second result and the fourth result represent an output of the binary convolution operation, and wherein the output of the binary convolution operation is stored within a register file of the processing device.

8. The processing device of claim 1, wherein the data comprises sensor data associated with a machine learning model, weight values of the machine learning model, and output values produced by a layer of the machine learning model.

9. An apparatus comprising:
a memory device configured to store program instructions, wherein the program instructions include a binary convolution instruction;
binary convolution circuitry configured to perform a binary convolution;
a set of destination registers;
a decoder coupled to the binary convolution circuitry; and
instruction fetch circuitry coupled to the memory device and the decoder, and configured to fetch the binary convolution instruction from the memory device, wherein the binary convolution instruction specifies a set of input data, a set of weight data, and the set of destination registers;
wherein the decoder is configured to cause the set of input data and the set of weight data to be provided to the binary convolution circuitry; and
wherein the binary convolution circuitry is configured to:
perform a binary convolution operation on the set of input data and the set of weight data to produce a set of output data; and
cause the set of output data to be stored in the set of destination registers.

10. The apparatus of claim 9 further comprising a data unit coupled to the binary convolution circuitry, wherein to cause the set of input data and the set of weight data to be provided to the binary convolution circuitry, the decoder is configured to provide register locations identified by the binary convolution instruction to the data unit.

11. The apparatus of claim 10, wherein the binary convolution circuitry comprises a plurality of channels, and wherein each of the plurality of channels includes an exclusive-nor (XNOR) circuit and, a counter circuit coupled to the XNOR circuit, and an accumulator circuit coupled to the counter circuit.

12. The apparatus of claim 11, wherein the data comprises multiple data elements, and wherein the XNOR circuit of each of the channels calculates an XNOR of a different combination of two of the multiple data elements relative to the XNOR circuit of each other of the channels, wherein the counter circuit of each of the channels performs a counting operation on a result of the XNOR circuit of each of the channels, and wherein the accumulator circuit adds the output of the counter circuit to the destination register.

13. The apparatus of claim 11, wherein the data comprises three data elements, and wherein the XNOR circuit of a first one of the channels calculates an XNOR of a first one of the three data elements and a third one of the three data elements and outputs a first result, and wherein the counter circuit of the first one of the channels performs a counting operation on the first result and outputs a second result, and wherein the accumulator circuit adds the second result to the destination register.

14. The apparatus of claim 13, wherein the XNOR circuit of a second one of the channels calculates an XNOR of a second one of the three data elements and the third one of the three data elements, and outputs a third result, wherein the counter circuit of the second one of the channels performs a counting operation on the third result and outputs a fourth result, and wherein the accumulator circuit adds the fourth result to the destination register.

15. The apparatus of claim 14, wherein the second result and the fourth result represent an output of the binary convolution operation, and wherein the output of the binary convolution operation is stored within a register file.

16. The apparatus of claim 9, wherein the data comprises sensor data associated with a machine learning model, weight values of the machine learning model, and output values produced by a layer of the machine learning model.

17. A computing apparatus comprising:
one or more computer readable storage media; and
program instructions stored on the one or more computer readable storage media;
wherein the program instructions include a binary convolution instruction that specifies a set of input data, a set of weight data, and a set of destination register, wherein the binary convolution instruction is configured to:
cause binary convolution circuitry to perform a binary convolution operation on the set of input data and the set of weight data; and
cause a result of the binary convolution operation to be stored in the set of destination registers.

18. The computing apparatus of claim 17, wherein the binary convolution instruction specifies register locations for registers that store the set of input data, the set of weight data, and the set of output data.

19. The computing apparatus of claim 17, wherein the binary convolution circuitry comprises a plurality of channels, and wherein each of the plurality of channels includes an exclusive-nor (XNOR) circuit, a counter circuit coupled to the XNOR circuit, and an accumulator circuit coupled to the counter circuit.

20. The computing apparatus of claim 19, wherein the data identified by the binary convolution instruction comprises multiple data elements, and wherein the binary convolution circuitry is configured to:
provide the multiple data elements to a first channel of the plurality of channels;
cause the XNOR circuit of the first channel to calculate an XNOR of a different combination of two of the multiple data elements relative to the XNOR circuit of each other of the channels to generate a first result;
load the first result to the counter circuit of the first channel;
cause the counter circuit to perform a counting operation on the first result to generate a second result;
load the second result to the accumulator circuit of the first channel; and
cause the accumulator circuit to add the second result to the destination register.
